(19) United States
(12) Patent Application Publication
(10) Pub. No.: US 2011/0001831 A1
(43) Pub. Date: Jan. 6, 2011

(54) Video Camera

(75) Inventor: Hideo NOGUCHI, Nishinomiya-shi (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/823,362

(22) Filed: Jun. 25, 2010

(30) Foreign Application Priority Data
Jul. 3, 2009 (JP) 2009-158349

(51) Int. Cl. H04N 5/225

(52) U.S. Cl. 348/169; 348/E05.024

(57) ABSTRACT

A video camera includes an imager. An imager repeatedly outputs an object scene image captured on an imaging surface. A determiner repeatedly determines whether or not one or at least two dynamic objects exist in the object scene by referring to the object scene image outputted from the imager. A first searcher searches a specific dynamic object that satisfies a predetermined condition from the one or at least two dynamic objects when a determination result of the determiner is updated from a negative result to an affirmative result. An adjuster adjusts an imaging condition by tracking the specific dynamic object discovered by the first searcher.

### CROSS REFERENCE OF RELATED APPLICATION

The disclosure of Japanese Patent Application No. 2009-158349, which was filed on Jul. 3, 2009, is incorporated herein by reference.

### BACKGROUND OF THE INVENTION

1. Field of the Invention

The present invention relates to a video camera. More particularly, the present invention relates to a video camera which images a dynamic object.

2. Description of the Related Art

According to one example of this type of camera, a motion occurring in a monitoring region is detected based on an image representing the monitoring region. If the motion is detected from the monitoring region, then one portion of the image corresponding to the detected motion is cut out from the image representing the monitoring region, and the one portion of the cut-out image is saved. Thereby, it is possible to reduce an image saving capacity.

However, a procedure for saving the image is started irrespective of a manner of the motion occurring in the monitoring region, and a start of the procedure for saving the image is not passed over depending on the manner of the motion occurring in the monitoring region. Thus, the above-described camera is limited in an imaging performance.

### SUMMARY OF THE INVENTION

A video camera according to the present invention, comprises: an imager which repeatedly outputs an object scene image captured on an imaging surface; a determiner which repeatedly determines whether or not one or at least two dynamic objects exist in the object scene by referring to the object scene image outputted from the imager; a first searcher which searches a specific dynamic object that satisfies a predetermined condition from the one or at least two dynamic objects when a determination result of the determiner is updated from a negative result to an affirmative result; and an adjuster which adjusts an imaging condition by tracking the specific dynamic object discovered by the first searcher.

An imaging control program product according to the present invention is an imaging control program product executed by a processor of a video camera provided with an imager which repeatedly outputs an object scene image captured on an imaging surface, an imaging control program product, comprises: a determining step of repeatedly determining whether or not one or at least two dynamic objects exist in the object scene by referring to an object scene image outputted from the imager; a searching step of searching a specific dynamic object that satisfies a predetermined condition from the one or at least two dynamic objects when a determination result of the determining step is updated from a negative result to an affirmative result; and an adjusting step of adjusting an imaging condition by tracking the specific dynamic object discovered by the searching step.

An imaging control method according to the present invention is an imaging control method executed by a video camera provided with an imager which repeatedly outputs an object scene image captured on an imaging surface, an imaging controlling method, comprising: a determining step of repeatedly determining whether or not one or at least two dynamic objects exist in the object scene by referring to an object scene image outputted from the imager; a searching step of searching a specific dynamic object that satisfies a predetermined condition from the one or at least two dynamic objects when a determination result of the determining step is updated from a negative result to an affirmative result; and an adjusting step of adjusting an imaging condition by tracking the specific dynamic object discovered by the searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of a motion detection area on an imaging surface;

FIG. 4 is a block diagram showing one example of a configuration of a motion detection circuit applied to the embodiment in FIG. 2;

FIG. 5 is a block diagram showing one example of a configuration of a face detection circuit applied to the embodiment in FIG. 2;

FIG. 6 is an illustrative view showing one example of a configuration of a register applied to the embodiment in FIG. 5;

FIG. 7 is an illustrative view showing one example of an object scene captured by the embodiment in FIG. 2;

FIG. 8(A) is an illustrative view showing one example of a motion area defined on a monitoring area;

FIG. 8(B) is an illustrative view showing one example of an object to be tracked;

FIG. 9 is an illustrative view showing another example of the object scene captured by the embodiment in FIG. 2;

FIG. 10 is an illustrative view showing still another example of the object scene captured by the embodiment in FIG. 2;

FIG. 11 is an illustrative view showing yet another example of the object scene captured by the embodiment in FIG. 2;

FIG. 12(A) is an illustrative view showing another example of the motion area defined on the monitoring area;

FIG. 12(B) is an illustrative view showing another example of the object to be tracked;

FIG. 13 is an illustrative view showing a further example of the object scene captured by the embodiment in FIG. 2;

FIG. 14 is a flowchart showing one portion of an operation of a CPU applied to the embodiment in FIG. 2;

FIG. 15 is a flowchart showing another portion of the operation of the CPU applied to the embodiment in FIG. 2;

FIG. 16 is a flowchart showing still another portion of the operation of the CPU applied to the embodiment in FIG. 2;

FIG. 17 is a flowchart showing yet another portion of the operation of the CPU applied to the embodiment in FIG. 2;

FIG. 18 is a flowchart showing a further portion of the operation of the CPU applied to the embodiment in FIG. 2;

FIG. 19 is a flowchart showing a further portion of the operation of the CPU applied to the embodiment in FIG. 2; and

FIG. 20 is an illustrative view showing another example of the object scene captured by another embodiment.

### DETAILED DESCRIPTION OF THE PREFERRED EMBODIMENTS

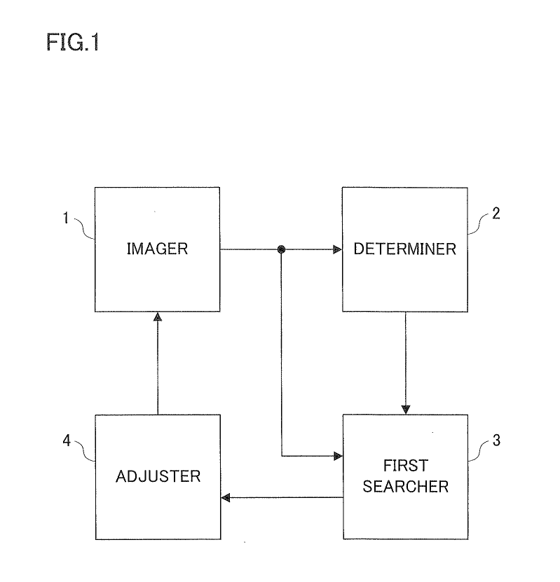

With reference to FIG. 1, a video camera according to one embodiment of the present invention is basically configured as follows: An imager 1 repeatedly outputs an object scene image captured on an imaging surface. A determiner 2 repeatedly determines whether or not one or at least two dynamic objects exist in the object scene by referring to the object scene image outputted from the imager 1. A first searcher 3 searches a specific dynamic object that satisfies a predetermined condition from the one or at least two dynamic objects when a determination result of the determiner 2 is updated from a negative result to an affirmative result. An adjuster 4 adjusts an imaging condition by tracking the specific dynamic object discovered by the first searcher 3.

Thus, when the one or at least two dynamic objects appear in the object scene, the specific dynamic object that satisfies the predetermined condition is sought therefrom. The imaging condition is adjusted by tracking the specific dynamic object. Limiting the dynamic object to be followed in this way leads to the realization of improvement in imaging performance.

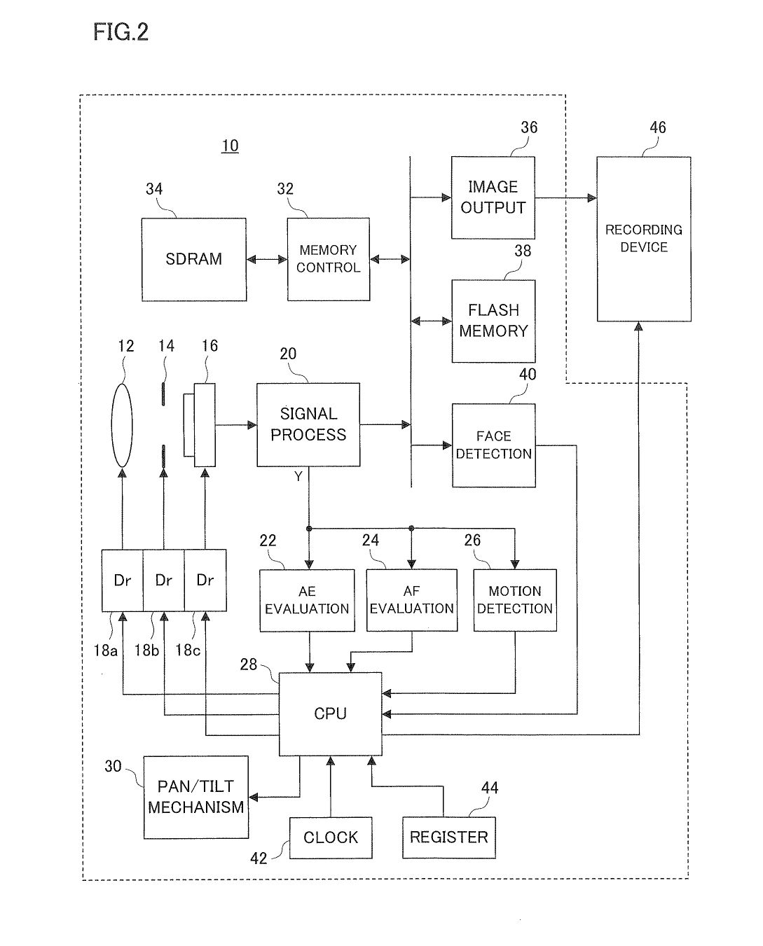

With reference to FIG. 2, a surveillance camera 10 according to this embodiment includes a focus lens 12 and an aperture unit 14 respectively driven by drivers 18a and 18b. An optical image of an object scene enters, with irradiation, an imaging surface of an image sensor 16 through these members. The imaging surface is covered with a primary color filter having a Bayer array (not shown). Therefore, in each pixel, electric charges having any one of color information, i.e., R (Red), G (Green), and B (Blue), are produced by photoelectric conversion.

In response to a vertical synchronization signal Vsync generated at every 1/60th of a second, a driver 18c exposes the imaging surface and reads out the electric charges produced on the imaging surface in a raster scanning manner. From the image sensor 16, raw image data representing the object scene is outputted at a frame rate of 60 fps.

A signal processing circuit 20 performs processes, such as white balance adjustment, color separation, and YUV conversion, on the raw image data outputted from the image sensor 16 so as to create YUV formatted-image data. The created image data is written into an SDRAM 34 through a memory control circuit 32. Moreover, the signal processing circuit 20 applies Y data, out of the image data created by the YUV conversion, to an AE evaluating circuit 22, an AF evaluating circuit 24, and a motion detection circuit 26.

Out of the Y data applied from the signal processing circuit 20, the AE evaluating circuit 22 integrates one portion of the Y data belonging to an evaluation area (not shown) at every 1/60th of a second, and outputs an integral value, i.e., a luminance evaluation value. Out of the Y data applied from the signal processing circuit 20, the AF evaluating circuit 24 integrates a high-frequency component of one portion of the Y data belonging to the evaluation area at every 1/60th of a second, and applies an integral value, i.e., a focus evaluation value, to a CPU 28.

When the imaging condition is adjusted by noticing a certain object existing in the object scene, the CPU 28 calculates an exposure amount that fits the noticed object based on the luminance evaluation value outputted from the AE evaluating circuit 22, and sets an aperture amount and an exposure time period defining the calculated exposure amount to the drivers 18b and 18c, respectively. Furthermore, the CPU 28 executes an AF process that fits the noticed object based on the focus evaluation value applied from the AF evaluating circuit 24, and sets the focus lens 12 to a focal point of the noticed object. Moreover, the CPU 28 drives a pan/tilt mechanism 30 so as to adjust an angle of the imaging surface so that the noticed object is placed at a center of the object scene.

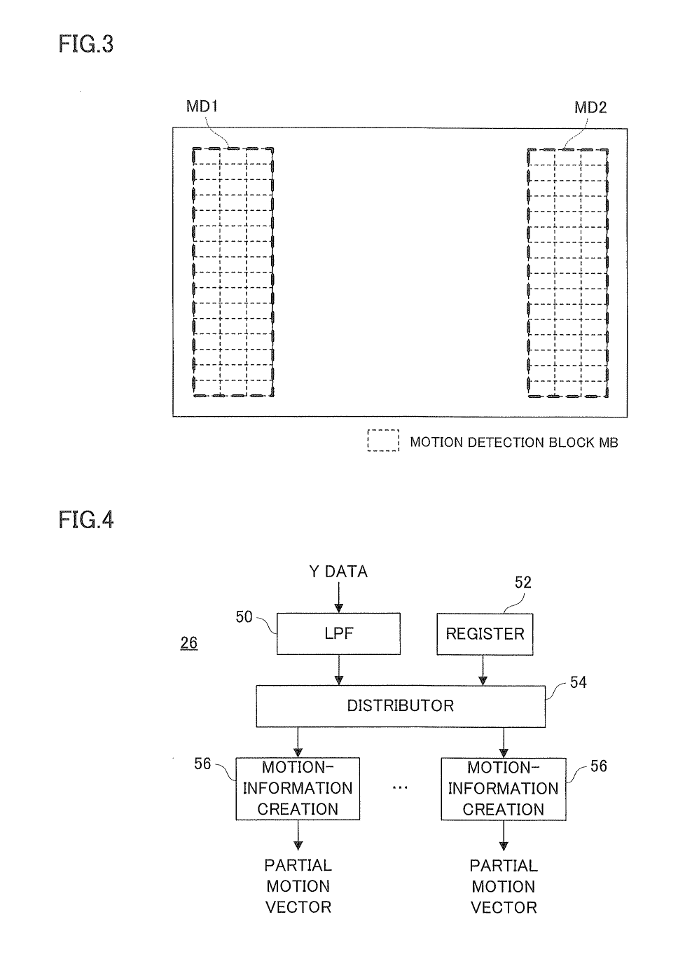

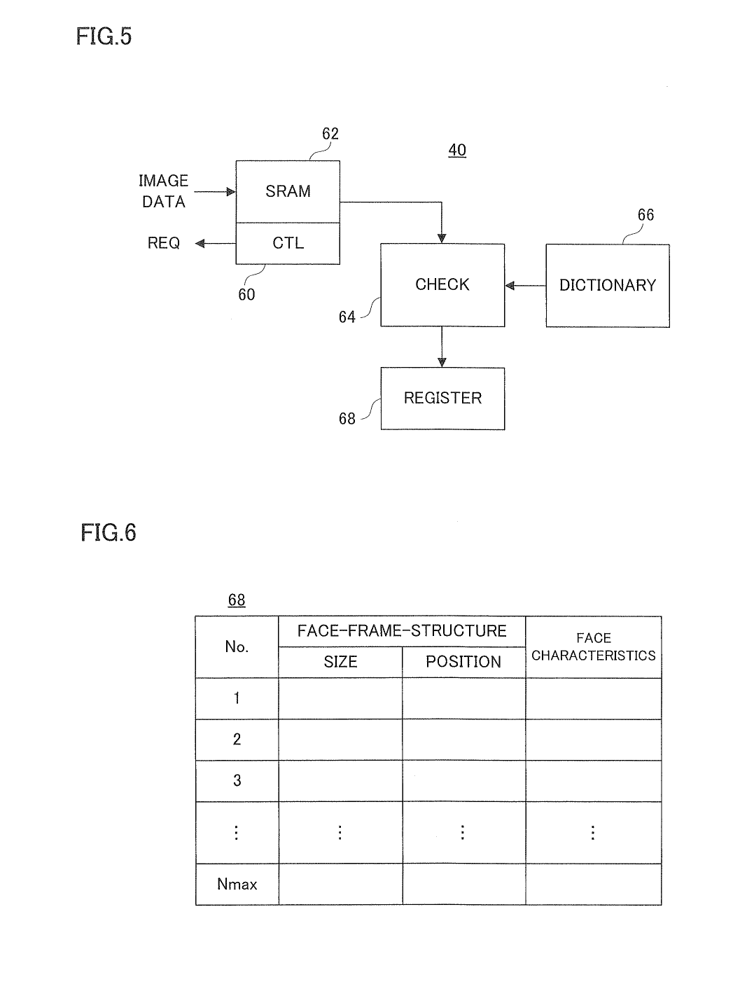

With reference to FIG. 3, a motion detection area MD1 is allocated to one side portion in a horizontal direction of the imaging surface, and a motion detection area MD2 is allocated to the other side portion in the horizontal direction of the imaging surface. Each of the motion detection areas MD1 and MD2 is formed by 48 motion detection blocks MB, MB, . . . . The motion detection circuit 26 creates a partial motion vector indicating the motion of the object scene in each motion detection block MB at every 1/60th of a second based on the Y data applied from the signal processing circuit 20, and outputs a total of 96 partial motion vectors toward the CPU 28.

The motion detection circuit 26 is configured as shown in FIG. 4. The raw image data is outputted from the image sensor 16 in a raster scanning manner, and therefore, the Y data also is inputted into the motion detection circuit 26 in a raster scanning manner. The inputted Y data is subjected to a noise removal process by an LPF 50, and then, the resultant Y data is applied, as Y_L data, to a distributor 54.

On a register 52, position information of 96 motion detection blocks MB, MB, . . . is registered. Moreover, in a subsequent stage of the distributor 54, 96 motion-information creating circuits 56, 56, . . . respectively corresponding to the 96 motion detection blocks are arranged.

With reference to the register 52, the distributor 54 determines for each pixel which of the 96 motion detection blocks MB, MB, . . . the Y_L data applied from the LPF 50 belongs to, and distributes the Y_L data to the motion-information creating circuit 56 corresponding to a determination result. The motion-information creating circuit 56 creates a partial motion vector representing the motion of the object scene in the corresponding motion detection block MB, based on the Y_L data applied from the distributor 54.

Returning to FIG. 2, the CPU 28 designates the motion detection area MD1 as the monitoring area when a time that a clock 42 indicates belongs to time zone of “T1” to “T2”, and sets “object moving in a right direction” and “moving speed of the object exceeding a reference value” to items on a monitoring condition. Moreover, the CPU 28 designates the motion detection area MD2 as the monitoring area when the time that the clock 42 indicates belongs to time zone of “T2” to “T1”, and sets “object moving in a left direction” and “moving speed of the object exceeding the reference value” to the items on the monitoring condition.

Forty-eight partial motion vectors respectively produced by 48 motion detection blocks MB, MB, . . . forming the monitoring area are fetched by the CPU 28 when a pan/tilt movement of the imaging surface is in a stopped state. The CPU 28 converts the 48 fetched partial motion vectors into a group for each partial motion vector indicating a common motion, and defines one or at least two motion areas within the monitoring area.

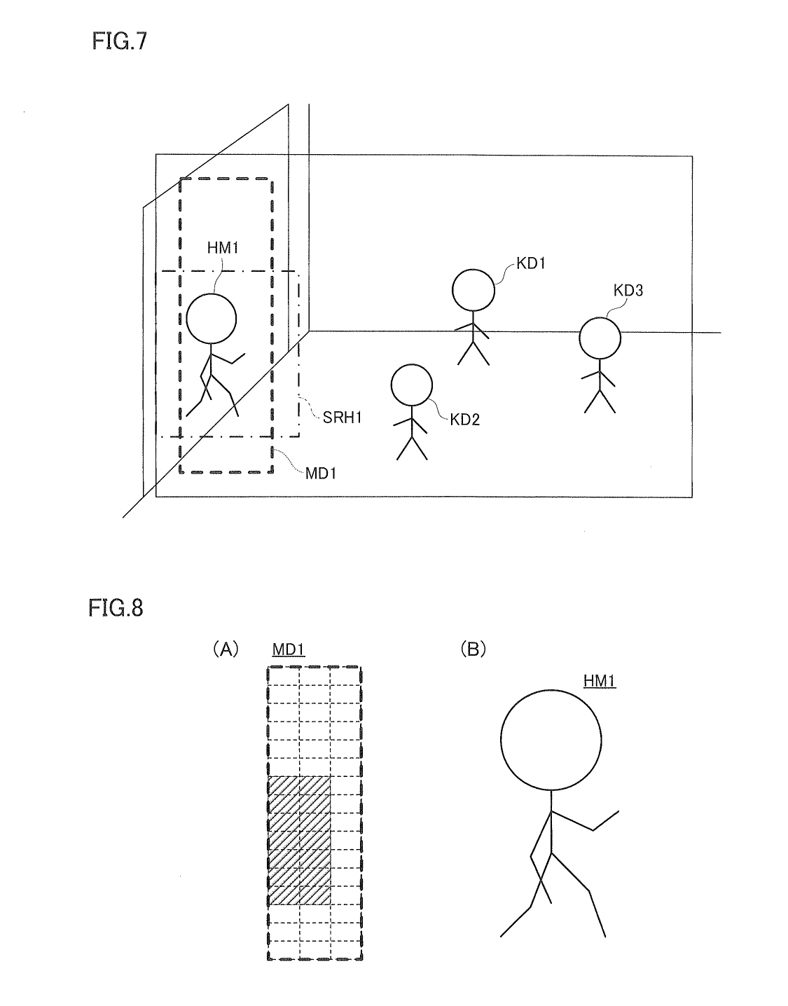

With reference to FIG. 7, when kids KD1 to KD3 are moving on a collider from the right side to the left side of the object scene in the time zone of “T1” to “T2”, if a human HM1 enters from the left side of the object scene, then the human HM1 is captured in the motion detection area MD1. In this case, an area indicated by hatching in FIG. 8(A) is defined as the motion area.

The CPU 28 combines the partial motion vectors belonging to the defined motion area, and checks the combined motion vector with the monitoring condition. When the motion vector satisfies the monitoring condition, the CPU 28 defines, as a tracking area, one portion of the area covering the corresponding motion area.

In the time zone of “T1” to “T2”, the monitoring condition has “object moving in the right direction” and “moving speed of the object exceeding the reference value” as the items. When the human HM1 shown in FIG. 7 enters at a speed exceeding the reference value, the motion vector indicating the motion of the human HM1 satisfies the monitoring condition. As a result, the tracking area SRH1 is defined as shown in FIG. 7.

Upon completion of defining the tracking area, the CPU 28 issues a recording start command toward an image output circuit 36 and a recording device 46. The image output device 36 reads out the image data accommodated in the SDRAM 34 at every 1/60th of a second, and outputs the read-out image data toward the recording device 46. The recording device 46 records the image data outputted from the image output circuit 36 on a recording medium (not shown).

Subsequently, the CPU 28 regards, as the object to be tracked, the object belonging to the defined tracking area, and registers a characteristic of the object to be tracked onto a register 44. In the above-described example, the human HM1 is regarded as the object to be tracked, and the characteristic of the human HM1 is registered onto the register 44, as shown in FIG. 8(B).

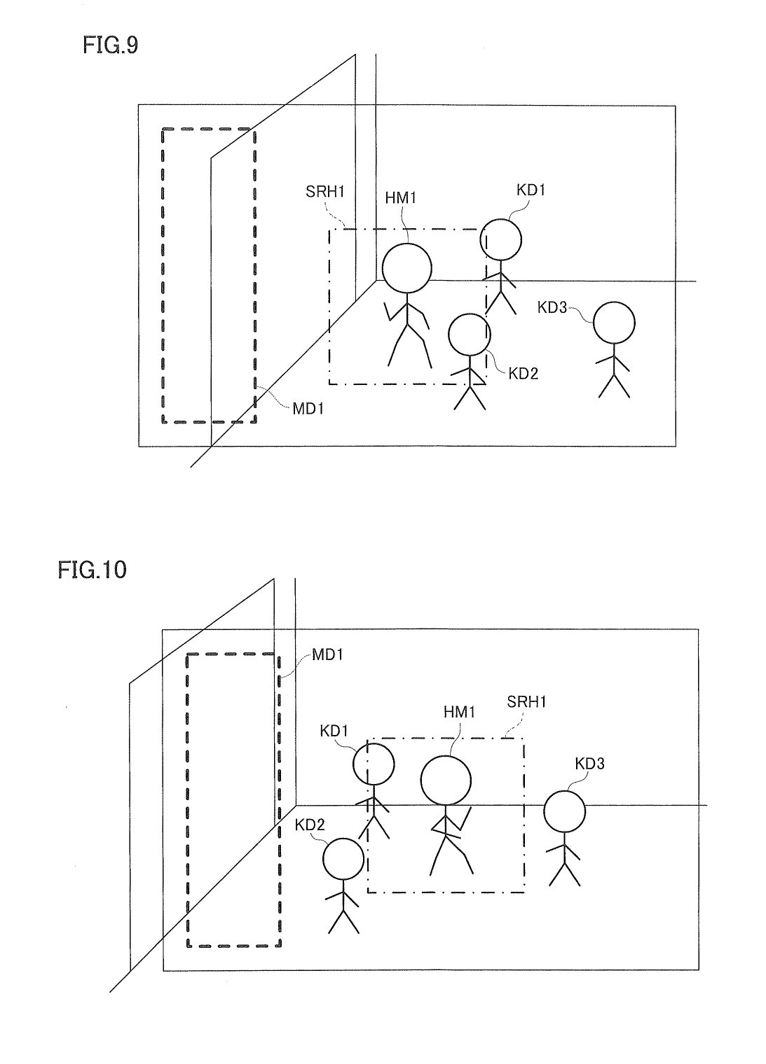

Upon completion of the registration onto the register 44, the CPU 28 adjusts the imaging condition such as the focus, the exposure amount, and the angle of the imaging surface while noticing the object to be tracked, and moves the tracking area so that the pan/tilt movement of the imaging surface is compensated. As a result, the object to be tracked and the tracking area move to the center of the object scene. In the above-described example, the imaging condition is adjusted while noticing the human HM1, and thereby, both the human HM1 and the tracking area SRH1 move to the center of the object scene (see FIG. 9).

Thereafter, the CPU 28 searches the object to be tracked from the tracking area by referring to the characteristic registered onto the register 44, and then adjusts the imaging condition while noticing the discovered object to be tracked, together with moving the tracking area so that the pan/tilt movement of the imaging surface is compensated. Therefore, when the human HM1 moves within the object scene, the angle of the imaging surface is adjusted so that the human HM1 and the tracking area SRH are positioned at the center of the object scene (see FIG. 10).

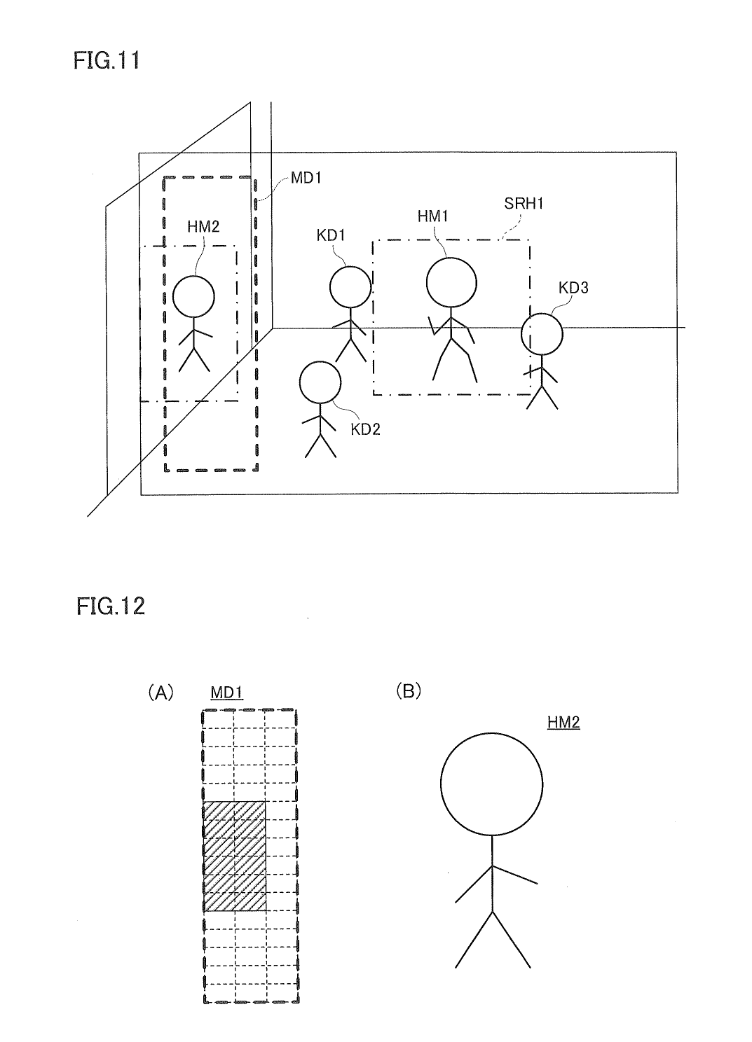

With reference to FIG. 11, when the human HM2 enters from the left side of the object scene at a speed exceeding the reference value, the human HM2 is captured in the motion detection area MD1. As a result, an area indicated by hatching in FIG. 12(A) is defined as the motion area, and the tracking area SRH2 is additionally defined as shown in FIG. 11.

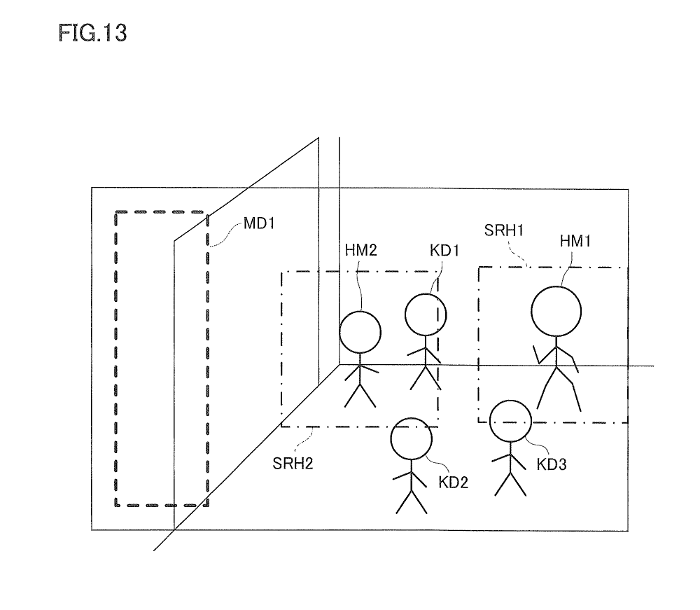

The CPU 28 regards, as the object to be tracked, the object belonging to the added tracking area, and additionally registers the characteristic of the object to be tracked onto the register 44. Furthermore, the CPU 28 adjusts the imaging condition such as the focus, the exposure amount, and the angle of the imaging surface while noticing the added object to be tracked, and moves the tracking area so that the pan/tilt movement of the imaging surface is compensated. As a result, in the above-described example, the angle of the imaging surface is adjusted so that the human HM2 and the tracking area SRH2 are positioned at the center of the object scene, and the object scene shown in FIG. 13 is captured on the imaging surface.

It is noted that when a plurality of objects to be tracked appear in the object scene in this way, the imaging condition is adjusted by noticing the latest object to be tracked. When any one of the plurality of objects to be tracked is disappeared from the object scene, the imaging condition is adjusted by noticing the latest object to be tacked, out of the objects to be tracked remaining in the object scene.

When all the objects to be tracked disappear from the object scene, the CPU 28 cancels the definition of the tracking area, and issues a recording end command toward the image output circuit 36 and the recording device 46. The image output device 36 ends the reading of the image data, and the recording device 46 ends recording of the image data.

During the execution of the recording process by the recording device 46, a face detection circuit 40 shown in FIG. 5 is started up for a face recognition process. With reference to FIG. 5, a controller 60 reads out the image data accommodated in the SDRAM 34 by each predetermined amount through the memory control circuit 32. The read-out image data is written into an SRAM 62. Subsequently, the controller 60 defines a checking frame on the SRAM 62, and transfers one portion of the image data belonging to the defined checking frame from the SRAM 62 to a checking circuit 64.

The checking circuit 64 checks the image data applied from the SRAM 62 with a template representing a face portion of a human. If the image data coincides with the template, then the checking circuit 64 regards, as a face portion image of the human, one portion of the image belonging to the checking frame at a current time point. A position and a size of the checking frame at a current time point are registered, as face-frame-structure information, onto a register 68, and a characteristic of the image within the checking frame at a current time point is registered, as face characteristic information, onto the register 68.

Definition of the checking frame is repeatedly changed so that the checking frame moves on the object scene by each predetermined amount in a raster direction. The checking process is repeatedly executed until the checking frame reaches a tail position of the object scene. As a result, in each of a plurality of columns forming the register 68, the face-frame-structure information and the face characteristic information are described. When the checking frame reaches the tail position of the object scene, a searching end notification is sent back from the checking circuit 64 to the CPU 28.

When the searching end notification is sent back, the CPU 28 specifies a characteristic that does not coincide with the characteristic of the object to be tracked registered on the register 44, out of Nmax characteristics registered on the register 68, and performs a mask process on the face image having the specified characteristic. As a result, in the above-described example, the mask process is performed on faces of the kids KD1 to KD3.

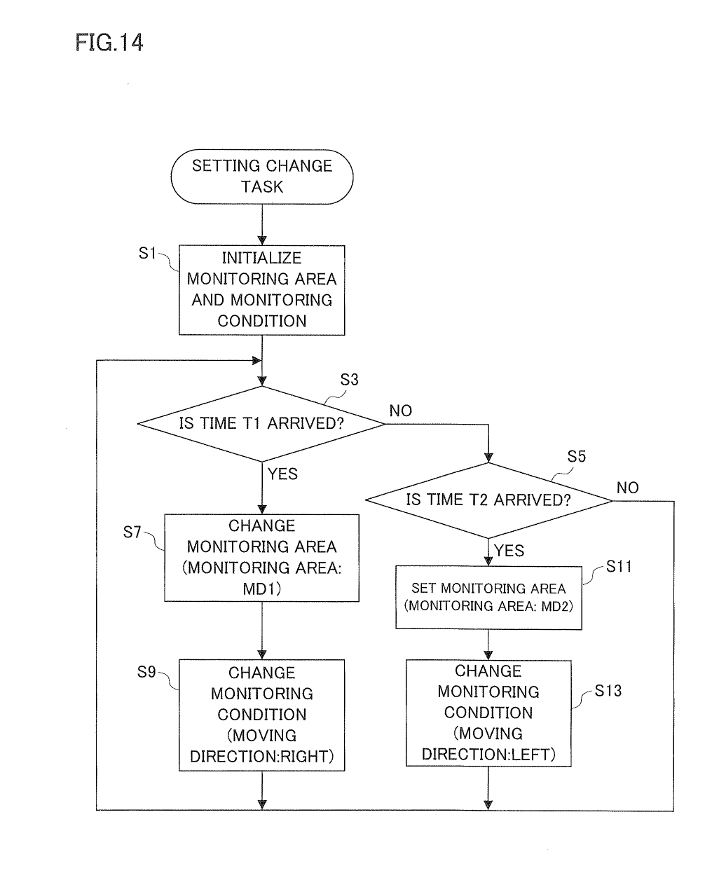

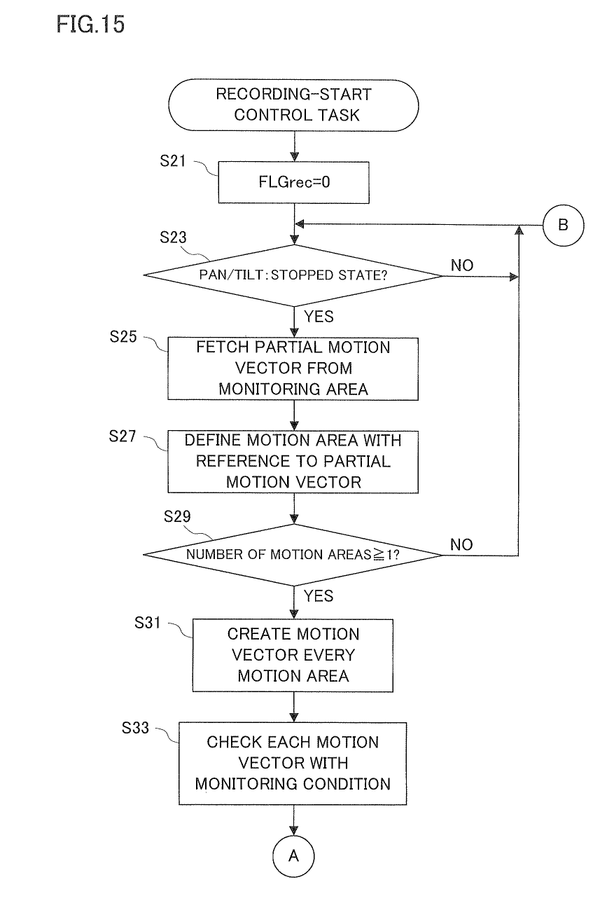

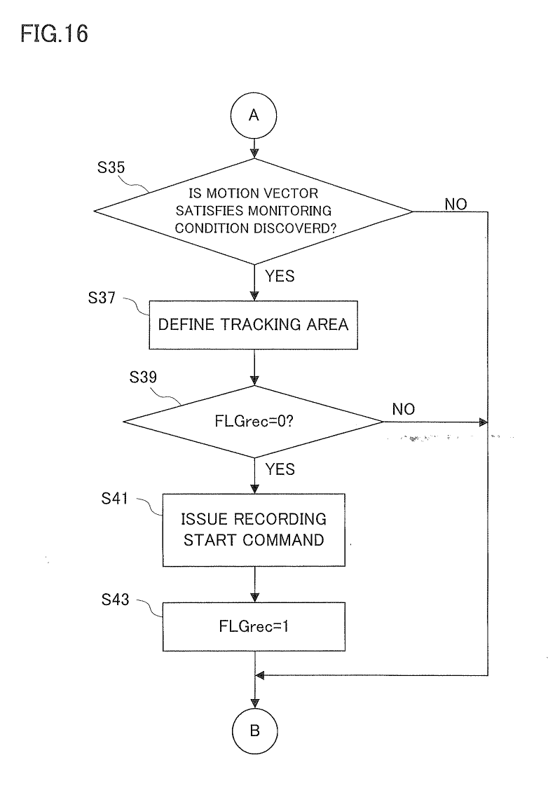

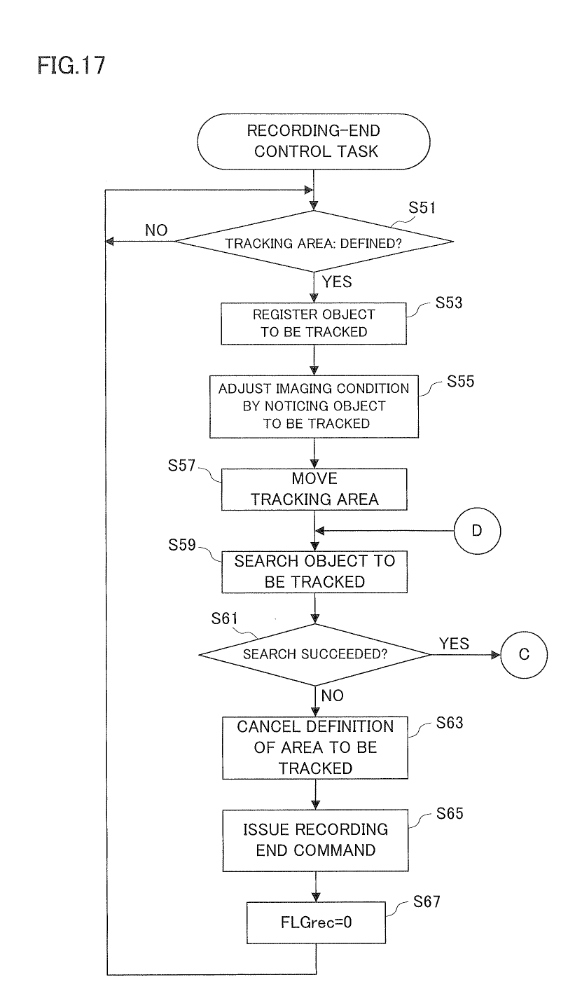

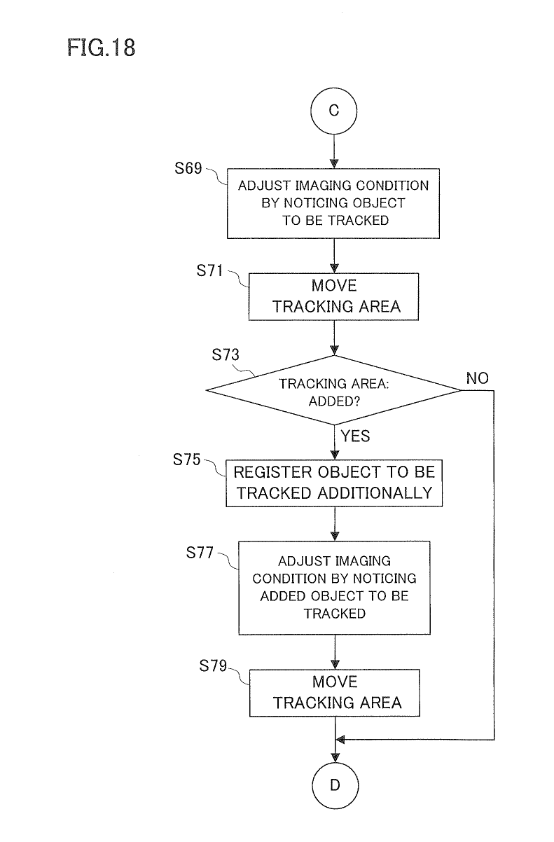

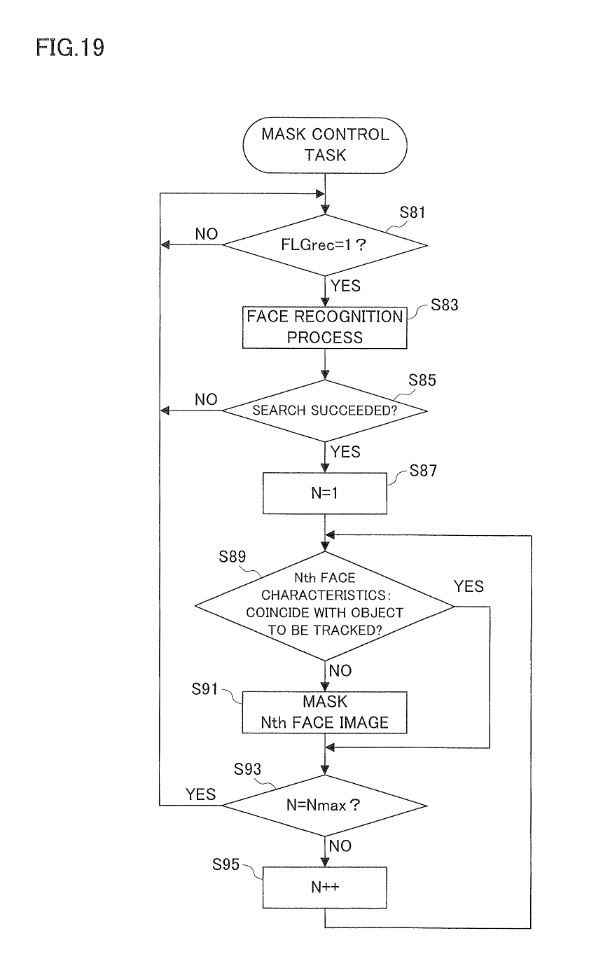

The CPU 28 executes a plurality of tasks including a setting change task shown in FIG. 14, a recording-start control task shown in FIG. 15 and FIG. 16, a recording-end control task shown in FIG. 17 and FIG. 18, and a mask control task shove in FIG. 19, in a parallel manner. It is noted that control programs corresponding to these tasks are stored in a flash memory not shown.

With reference to FIG. 14, in a step S1, the monitoring area and the monitoring condition are initialized. Thereby, the motion detection area MD1 is designated as the monitoring area, and “object moving in the right direction” and “moving speed of the object exceeding the reference value” are set as the monitoring condition. In a step S3, it is determined whether or not the time T1 is arrived. In a step S5, it is determined whether or not the time T2 is arrived. When YES is determined in the step S3, processes in steps S7 to S9 are executed. When YES is determined in the step S5, processes in steps S11 to S13 are executed.

In the step S7, the motion detection area MD1 is designated as the monitoring area. In the step S9, the item regarding a moving direction, out of the monitoring condition, is changed to “object moving in the right direction”. In the step S11, the motion detection area MD2 is designated as the monitoring area. In the step S13, the item regarding the moving direction, out of the monitoring condition, is changed to “object moving in the left direction”. Upon completion of the process in the step S9 or S13, the process returns to the step S3.

With reference to FIG. 15, in a step S21, a flag FLGrec is set to “0”. In a step S23, it is determined whether or not the pan/tilt movement of the imaging surface is in the stopped state. When a determination result is updated from NO to YES, the process advances to a step S25 so as to fetch from the motion detection circuit 26 the 48 partial motion vectors produced in the 48 motion detection blocks MB, MB, . . . forming the monitoring area. In a step S27, the 48 fetched partial motion vectors are grouped for each partial motion vector indicating a common motion, and the motion area is defined within the monitoring area. It is noted that unless the motion is generated within the monitoring area, the motion area is not defined.

In a step S29, it is determined whether or not the number of motion areas defined is equal to or more than one. When a determination result is NO, the process returns to the step S23 while when the determination result is YES, the process advances to a step S31. In the step S31, one or at least two motion vectors respectively corresponding to the one or at least two defined motion areas are created based on the 48 partial motion vectors fetched in the step S25.

In a step S33, each of the one or at least two created motion vectors is checked with the monitoring condition. In a step S35, it is determined whether or not the motion vector that satisfies the monitoring condition is discovered. When a determination result is NO, the process returns to the step S23, and when the determination result is YES, the process advances to a step S37.

In the step S37, the motion area corresponding to the motion vector that satisfies the monitoring condition is specified, and one portion of the area covering the specified motion area is defined as the tracking area. If the number of motion vectors that satisfy the monitoring condition is equal to or more than “2”, then at least two tracking areas are defined. In a step S39, it is determined whether or not the flag FLGrec is “0”. When a determination result is NO, the process returns to the step S23 while when the determination result is YES, the process advances to a step S41. In a step S41, the recording start command is issued toward the image output circuit 36 and the recording device 46. In a subsequent step S43, the flag FLGrec is updated to “1”. Upon completion of the updating process, the process returns to the step S23.

With reference to FIG. 17, it is repeatedly determined in a step S51 whether or not the tracking area is defined. If a determination result is updated from NO to YES, then the process advances to a step S53. In the step S53, the object belonging to the tracking area is regarded as the object to be tracked, and the characteristic of the object to be tracked is registered onto the register 44. In a step S55, the imaging condition such as the focus, the exposure amount, and the angle of the imaging surface are adjusted by noticing the tracking area.

It is noted that if the number of the defined tracking area is equal to or more than “2”, then the characteristics of at least two objects to be tracked are registered onto the register 44, and the imaging condition is adjusted by noticing any one of the objects to be tracked. When the angle of the imaging surface is adjusted, the object to be tracked that is noticed moves to the approximate center of the object scene.

In a step S57, the tracking area is moved so that the pan/tilt movement of the imaging surface is compensated. In a step S59, with reference to the characteristics registered on the register 44, the object to be tracked is searched from the tracking area. It is noted that when a plurality of tracking areas are defined, all the tracking areas are moved and the object to be tracked is searched for each tracking area.

If none of the objects to be tracked are discovered by the searching process in the step S59, then NO is determined in a step S61, and all the definitions for the tracking area are cancelled in a step S63. In a step S65, the recording end command is issued toward the image output circuit 36 and the recording device 46. In a subsequent step S67, the flag FLGrec is changed to “0”. Upon completion of the process in the step S67, the process returns to the step S51.

When at least one object to be tracked can be discovered by the searching process in the step S59, YES is determined in a step S61 and processes similar to those in the steps S55 to S57 are executes in steps S69 to S71. In a step S73, it is determined whether or not the tracking area is added as a result of the process in the step S37. When a determination result is NO, the process returns to the step S59, and when the determination result is YES, the process advances to a step S75.

In the step S75, the object belonging to the tracking area is regarded as the object to be tracked, and the characteristic of the object to be tracked is additionally registered onto the register 44. In a step S77, the imaging condition is adjusted by noticing the added object to be tracked. In a step S79, all the tracking areas are moved so that the pan/tilt movement of the imaging surface is compensated. Similar to the above-described case, if the number of the added tracking area is equal to or more than “2”, then the characteristics of at least two objects to be tracked are additionally registered onto the register 44, and the imaging condition is adjusted by noticing any one of the objects to be tracked. Upon completion of the process in the step S79, the process returns to the step S59.

With reference to FIG. 19, it is determined in a step S81 whether or not the flag FLGrec indicates “1”. When a determination result is updated from NO to YES, the process advances to a step S83, and then, issues a search request to the face detection circuit 40 for the purpose of a face recognition process. When a search end notification is sent back from the face detection circuit 40, it is determined in a step S85 whether or not the face recognition is successful.

If at least one face frame has been registered on the register 68 shown in FIG. 5, the process advances to a step S87 after regarding that the face recognition is successful. On the other hand, if none of the face frames have been registered on the register 68, the process returns to the step S81 after regarding that even a single face portion image of the human does not exist in the object scene.

In the step S87, a variable N is set to “1”. In a step S89, it is determined whether or not a characteristic described in an N-th column of the register 68 coincides with the characteristic of the object to be tracked. When a determination result is YES, the process directly advances to a step S93 while when the determination result is NO, the process advances to the step S93 after undergoing a process in a step S91. In the step S91, the mask process is performed on the image belonging to the face frame to be noticed.

In the step S93, it is determined whether or not the variable N reaches “Nmax”. When NO is determined, the process increments the variable N in a step S95, and then, the process returns to the step S89. When a determination result is YES, the process returns to the step S81.

As understood from the above description, the image sensor 16 repeatedly outputs the object scene image captured on the imaging surface. The CPU 28 repeatedly determines whether or not one or at least two dynamic object exist in the object scene by referring to the object scene image outputted from the image sensor 16 (S25 to S29). When the determination result is updated from NO to YES, the CPU 28 searches the specific dynamic object that satisfies the monitoring condition from the one or at least two dynamic objects (S31 to S35), and searches the discovered specific dynamic object so as to adjust the imaging condition (S37, S51 to 61, S69 to S79).

In this way, when the one or at least two dynamic objects appear in the object scene, the specific dynamic object that satisfies the monitoring condition is searched therefrom. The aging condition is adjusted by tracking the specific dynamic object. When the dynamic object to be followed is thus limited, an improvement in imaging performance is realized.

It is noted that in this embodiment as the items of the monitoring condition, the moving direction and the moving speed of the object are assumed, a size of the object, however, may be optionally added to the items of monitoring condition.

Moreover, in this embodiment, the surveillance camera is assumed, the present invention can, however, also be applied to a household-use video camera. For example, when a child competing in a footrace for a sports festival is shot by using the video camera to which the present invention is applied, video-recording is started when a front-running child appears in a side portion in a horizontal direction of the object scene and is ended when all the children participating in the footrace disappear from the object scene.

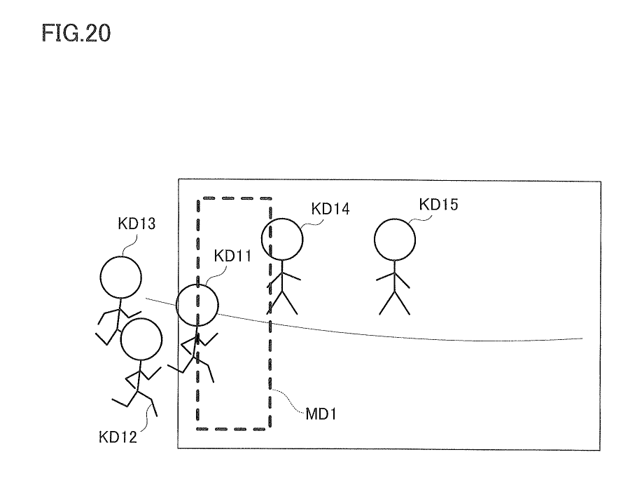

With reference to FIG. 20, it is assumed that a situation of a sports festival in which kids KD11 to KD13 run on a track field in a footrace and kids KD14 and KD15 watch the footrace outside the track field is shot by a household-use video camera supported by a tripod so that the pan/tilt movement is enabled.

When the kid KD14 enters into the motion detection area MD1 from a right side, and then, the kid KD11 enters into the motion detection area MD1 from a left side, the video-recording is started not at a time of the entering of the kid KD14 but at a time of the entering of the kid KD11. The imaging condition such as the exposure amount, the focus, and the angle of the imaging surface is adjusted by noticing the kid KD11. If the kids KD11 to KD13 disappear from the object scene resulting from a delay of the pan/tilt movement or a limitation of a pan/tilt range, then the video-recording is ended. Thereby, an effective video-recording process is realized.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A video camera, comprising:
an imager which repeatedly outputs an object scene image captured on an imaging surface;
a determiner which repeatedly determines whether or not one or at least two dynamic objects exist in the object scene by referring to the object scene image outputted from said imager;
a first searcher which searches a specific dynamic object that satisfies a predetermined condition from the one or at least two dynamic objects when a determination result of said determiner is updated from a negative result to an affirmative result; and
an adjuster which adjusts an imaging condition by tracking the specific dynamic object discovered by said first searcher.

2. A video camera according to claim 1, wherein the predetermined condition includes, as a parameter, a moving direction and/or a moving speed of the dynamic object.

3. A video camera according to claim 1, wherein said adjuster includes a registerer which registers a characteristic of the specific dynamic object, and an object searcher which searches the specific dynamic object from the object scene by referring to the characteristic registered by said registerer.

4. A video camera according to claim 3, wherein the object scene image referred to by said determiner is equivalent to one portion of the object scene image corresponding to a side portion of the object scene, an adjusting process of said adjuster includes a process for adjusting an angle of the imaging surface so that the specific dynamic object is captured at a center portion of the object scene, and said object searcher executes a searching process by referring to a latest characteristic registered by said registerer.

5. A video camera according to claim 4, further comprising a start-up controller which starts up said determiner when the angle of the imaging surface is stopped.

6. A video camera according to claim 4, further comprising:
a first changer which changes the side portion to be noticed by said determiner at each time a designated time arrives; and
a second changer which changes a content of the predetermined condition, corresponding to a change process of said first changer.

7. A video camera according to claim 1, further comprising:
a second searcher which searches a face portion of a human from the object scene by referring to the object scene image outputted from said imager;
a processor which performs a special-effect process on an image equivalent to the face portion discovered by said second searcher; and
a controller which controls permission/restriction of the special-effect process by checking a characteristic of the face portion discovered by said second searcher with a characteristic of the specific dynamic object discovered by said first searcher.

8. A video camera according to claim 7, wherein the special-effect process is equivalent to a mask process, and said controller restricts the mask process when a pattern of the face portion coincides with a pattern registered by said registerer.

9. An imaging control program product executed by a processor of a video camera provided with an imager which repeatedly outputs an object scene image captured on an imaging surface, an imaging control program product, comprising:
a determining step of repeatedly determining whether or not one or at least two dynamic objects exist in the object scene by referring to an object scene image outputted from said imager;
a searching step of searching a specific dynamic object that satisfies a predetermined condition from the one or at least two dynamic objects when a determination result of said determining step is updated from a negative result to an affirmative result; and
an adjusting step of adjusting an imaging condition by tracking the specific dynamic object discovered by said searching step.

10. An imaging control method executed by a video camera provided with an imager which repeatedly outputs an object scene image captured on an imaging surface, an imaging controlling method, comprising:
a determining step of repeatedly determining whether or not one or at least two dynamic objects exist in the object scene by referring to an object scene image outputted from said imager;
a searching step of searching a specific dynamic object that satisfies a predetermined condition from the one or at least two dynamic objects when a determination result of said determining step is updated from a negative result to an affirmative result; and
an adjusting step of adjusting an imaging condition by tracking the specific dynamic object discovered by said searching step.
